(19) United States
(12) Patent Application Publication
(10) Pub. No.: US 2021/0036924 A1
(43) Pub. Date: Feb. 4, 2021

(54) MANAGING HOST SPAN INFORMATION FOR LOGICAL ENTITIES IN SOFTWARE DEFINED NETWORKS

(71) Applicant: VMware, Inc., Palo Alto, CA (US)

(72) Inventors: Yanjun Lin, Sunnyvale, CA (US); Yang Ping, San Jose, CA (US); Wei Guo, Sunnyvale, CA (US); Li Sun, Palo Alto, CA (US)

(21) Appl. No.: 16/526,755

(22) Filed: Jul. 30, 2019

(51) Int. Cl. H04L 12/24; G06F 16/901; H04L 12/713; H04L 12/931; H04L 12/715

(52) U.S. Cl. CPC H04L 41/0893; G06F 16/9024; H04L 45/586; H04L 41/0853; H04L 41/12; H04L 45/64; H04L 41/0816; H04L 49/70

(57) ABSTRACT

Described herein are systems and methods to manage and identify host spans of logical entities in software defined networks. In one example, a control system may identify a first graph that includes nodes that represent logical entities and hosts and further includes directional edges that represent a topology of the logical entities and hosts. The control system further identifies groups of strongly connected components in the first graph and generates a second graph based on the identified groups. The second graph includes nodes that represent the groups and any nodes of the first graph not included in the groups, and further includes directional edges that indicate a topology of the nodes. The control system may then follow the directional edges of the second graph to allocate host spans to the logical entities represented in the nodes.

### BACKGROUND

Software defined networks include logical entities that provide various networking operations for computing elements, such as virtual machines and containers. The networking operations may include routing operations, switching operations, firewall operations, or some other networking operations. In implementing software defined networks, administrators associated with the software defined networks may define a topology configuration that indicates how the various computing elements and logical entities are coupled. This may include connecting virtual machines to logical switches, coupling the logical switches to logical routers, or defining some other network topology.

When the software defined networks are deployed in a computing environment, the administrators that defined the topology may be unable control where each of the logical entities are distributed on the hosts of the computing environment. For example, a single logical switch may be distributed across multiple hosts to provide the network functionality for virtual machines coupled to the logical switch. To determine the current deployment location for the logical entities, a control system may receive reports that indicate host locations for the various logical entities. The reports may then be used in conjunction with the configuration topology defined by the administrators to determine the host spans associated with each of the logical entities. These host spans may be used in determining where configuration modifications should be delivered in the computing environment. In an example, when a configuration modification request is generated for a logical router deployed in the computing system, the control system may identify the hosts in the span for the logical router and provide configuration modification data to the corresponding hosts.

However, as additional computing systems and logical entities are deployed in a computing environment, managing the host spans for each of the logical entities may become difficult and cumbersome. As a result, complications can arise when a modification is required for a logical entity that spans multiple hosts in the computing environment.

### Overview

The technology disclosed herein provides enhancements for managing host span information for logical entities in software defined networks. In one implementation, a control system identifies a first graph which comprises nodes that represent one or more hosts and one or more logical entities of a software defined network and further comprises directional edges that indicate a topology of the nodes in the first graph. The control system further identifies one or more groups of strongly connected components in the first graph. Once identified, the control system generates a second graph based on the identified one or more groups, wherein the second graph comprises nodes that represent the one or more groups and any nodes of the first graph not included in the one or more groups, and wherein the second graph further comprises directional edges that a topology of the nodes in the second graph. After the second graph is generated, the control system may identify a host span for each of the nodes in the second graph based on the directional edges in the second graph.

### BRIEF DESCRIPTION OF THE DRAWINGS

FIGS. 1A and 1B illustrate graphs for managing span information for logical entities according to an implementation.

FIG. 2 illustrates an operation of a control system to manage span information for logical entities according to an implementation.

FIGS. 3A and 3B illustrate an example update to a software defined networking configuration according to an implementation.

FIG. 4 illustrates an operation of a control system to manage updates in graphs according to an implementation.

FIGS. 5A and 5B illustrate an example update to a software defined networking configuration according to an implementation.

FIG. 6 illustrates an operation of a control system to manage updates in graphs according to an implementation.

FIG. 7 illustrates a computing system to manage span information for logical entities according to an implementation.

### DETAILED DESCRIPTION

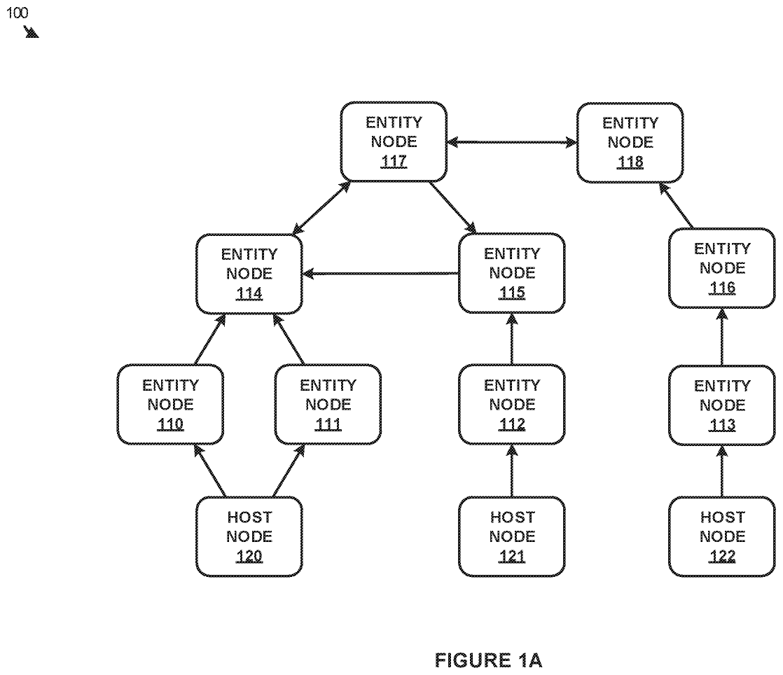

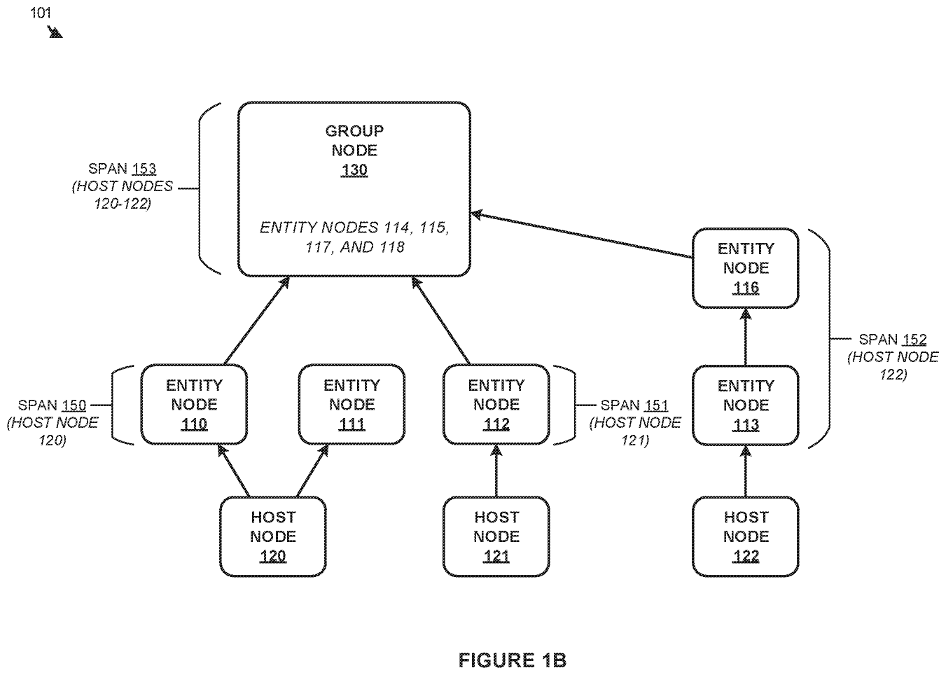

FIGS. 1A and 1B illustrate graphs for managing span information for logical entities according to an implementation. FIG. 1A includes graph 100 with host nodes 120-122 and entity nodes 110-118, wherein the nodes are coupled via directional edges. FIG. 1B includes graph 101 with entity nodes 110-113 and 116, host nodes 120-122, and group node 130 that encompasses entity nodes 114-115, and 117-118. Entity nodes 110-113 and 116, host nodes 120-122 and group node 130 are coupled via directional edges.

Referring first to FIG. 1A, FIG. 1A represents a graph capable of demonstrating a topology for a software defined network. In particular, host computing systems in a computing environment may generate reports that are provided to a control systems of the computing environment. These reports may provide an identifier for the host and may identify any logical entities that are located on the host. Once the information is reported for the hosts, the information may be combined with a configuration generated by an administrator of the network to generate graph 100 that represents a current topology of the network. In the current example, graph 100 includes host nodes 120-122 that correspond to hosts in a computing environment, while entity nodes 110-118 are representative of logical entities that execute on the host computing systems. The logical entities may comprise logical switches, logical routers, or some other logical entity for a software defined network. As an example, entity node 116 may represent a logical switch that executes on a host that corresponds to host node 122. As a result, host 122 may provide a report that indicates the logical switch is operating on the host, and the controller may update the topology of graph 100 to reflect the execution location of the virtual switch.

In addition to the nodes in graph 100, graph 100 further includes directional edges that are used to represent dependencies in the network topology. These dependencies may comprise routing dependencies, such as logical switches providing configuration information to logical routers, and may further comprise execution dependencies, such as entity node 112 executing on host node 121. The directional edges may comprise single direction edges or may comprise bidirectional edges that demonstrate logical entities that are codependent in the software defined network structure.

Turning to FIG. 1B, FIG. 1B includes graph 101 that is representative of a graph generated from graph 100 of FIG. 1A. In generating graph 101, the control system may identify one or more groups of strongly connected components in graph 100. A group of entity nodes in graph 100 is strongly connected if every node is reachable by every other node within the same group. Accordingly, based on the directional edges of graph 100, entity nodes 114, 115, 117, and 118 are strongly connected because each node in the group can reach every other node in the group. Once a group is identified, the entity nodes may be combined into group node 130. As no other groups are strongly connected, the other entity nodes may not be combined into larger group nodes for graph 101. After the group nodes are identified for the graph, edges may be added that maintain the dependencies from graph 100. Here, because group node 130 encompasses multiple entity nodes, group node 130 now is connected to entity node 110, entity node 112, and entity node 116.

Once graph 101 is generated, host spans may be identified for each of the nodes that identify hosts relevant to configuration changes of logical entities represented by the nodes. To identify the span associated with each of the nodes, the control system may start at a host, such as host node 120, and traverse or follow the directional edges of the graph to propagate the span to the other nodes in graph 101. As an example, starting at host node 120, the span may be propagated upward following the directed edges to entity nodes 110-111, which correspond to span 150, and further propagated to group node 130, which corresponds to span 153. Additionally, starting at host node 121, the span may be propagated to entity node 112, which corresponds to span 151, and further propagated to group node 130 that corresponds to span 153. Moreover, host node 122 may be propagated to entity node 113 and entity node 116 that correspond to span 152, and further propagated to group node 130 that corresponds to span 153. When a configuration modification request is generated for a logical entity represented in graph 101, the control system may identify the node that represents the logical entity and forward a modification to the hosts in the span that correspond to the logical entity. Thus, if a configuration modification is generated for a logical entity that corresponds to entity node 114, the control system may identify group node 130 to support the request and forward a modification to the hosts associated with span 153.

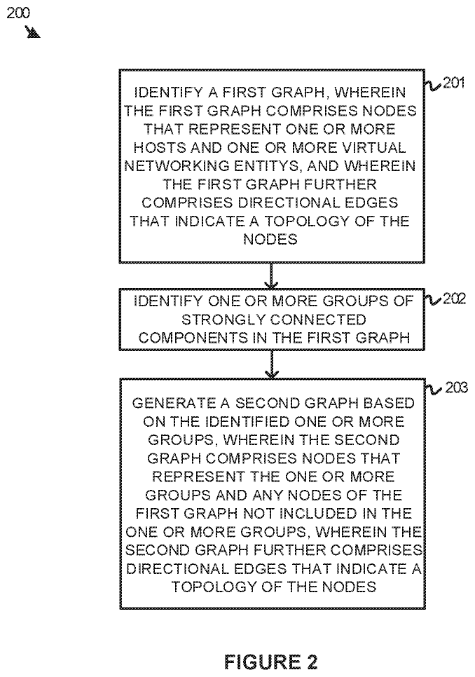

FIG. 2 illustrates an operation 200 of a control system to manage span information for logical entities according to an implementation. The processes of operation 200 are referenced parenthetically in the paragraphs that follow with reference to elements of graphs 100-101 of FIGS. 1A and 1B.

As depicted, operation 200 includes identifying (201) a first graph, wherein the first graph comprises nodes that represent one or more hosts and one or more logical entities of a software defined network, and wherein the first graph further comprises directional edges that indicate a topology of the nodes in the first graph. In some implementations, an administrator or administrators associated with software defined networks may define a network configuration that indicates how virtual nodes, logical switches, logical routers, and other networking elements are arranged in a network. In addition to the information provided from the administrators creating the network, the control system may also obtain information about how each of the logical entities are deployed to the host computing systems in the computing environment. In some implementations, while the administrator may define how the various logical entities are communicatively coupled, the various entities may be deployed across multiple hosts in a computing environment. For example, a logical switch may be deployed across multiple hosts to support the required virtual machines in the computing environment. To obtain the deployment information, the hosts may provide reports that indicate the various logical entities executing on the host. Referring to graph 100 of FIG. 1, entity nodes 110-111 may execute on a host associated with host node 120, while entity node 112 executes on host 121. As the reports are obtained for the various hosts of the computing environment, the control system may combine the information from the reports with the configuration information provided by the administrators to generate graph 100. Graph 100 includes nodes representative of hosts as host nodes 120-122 and nodes representative of the various logical entities as entity nodes 110-118.

After identifying graph 100, operation 200 further identifies (202) one or more groups of strongly connected components in the first graph. To identify the strongly connected components, the control system may perform an algorithm capable of identifying groups of nodes where each node is capable of reaching all other nodes in the same group. For example, in graph 100 entity nodes 114, 115, 117, and 118 are each capable of communicating with the other nodes in the group. Once a group is identified, the operation may further generate (203) a second graph based on the identified one or more groups, wherein the second graph comprises nodes that represent the one or more groups and any nodes of the first graph not included in the one or more groups, and wherein the second graph further comprises directional edges that indicate a topology of the nodes in the second graph. In generating the second graph from the first graph, the control system may generate nodes that correspond to the group nodes identified from the first graph. Once the group nodes are added, any nodes of the first graph that were not part of the group nodes may be added to the graph, wherein the nodes may represent logical entities or hosts that do not belong to a strongly connected component group.

Referring to an example of graph 101 of FIG. 1B, group node 130 is added to the graph to represent a group of entity nodes 114, 115, 117, and 118. Additionally, nodes are added to the graph that correspond to the entity nodes and host nodes that are not included in group node 130. Once added, directional edges are added that maintain the topology from graph 100 of FIG. 1A. After graph 101 is generated by combining nodes into group nodes, the control system may propagate the spans of each of the hosts throughout the graphs. In particular, following the directional edges, hosts may be added to the spans of corresponding nodes in graph 101. Here, host node 120 may be propagated to entity nodes 110-111 and group node 130, host node 121 may be propagated to entity node 112 and group node 130, and host node 122 may be propagated to entity node 113, entity node 116, and group node 130. This propagation of the hosts in graph 101 may yield spans 150-153 that can be used in identifying hosts associated with configuration modifications. For example, when a modification is required for the logical entity associated with entity node 116, the control system may identify span 152 is associated with entity node 116. Once identified, the control system may initiate operations to provide the configuration modification to the host associated with host node 122.

In some implementations, each of the nodes in the second graph may include or be associated with metadata that indicates the span for the node, the logical entity or entities associated with the node, information about the preceding nodes and succeeding nodes, host span information for the node, or some other information related to the logical entities.

Although demonstrated in the example of FIG. 2 with an initial generation of a graph, it should be understood that the control system may provide further operations to update the graph with the group nodes. These operations may include adding or removing new nodes to represent logical entities or hosts, adding or removing directed edges, or providing some other operation to reflect an update to the network. The update may be generated based on a change from an administrator (i.e., the administrator removing a logical entity) or may be generated based on migrations of logical entities in the computing environment. When an update occurs, the control system may determine if any changes have occurred for the strongly connected component groups and may update the groups if changes have been identified. For example, when a new directed edge is added to the graph based on a configuration modification, the control system may determine if the new edge forms a strongly connected component group. If formed, two or more nodes may be combined into a new group node and the host spans of the graph may be updated based on propagating the spans using the directed edges.

In another example, rather than adding an edge, a modification may remove a connection between two logical entities in the network. When the connection is removed, the control system may determine whether the two entities correspond to a group node. If the two nodes are not part of a group node, then the control node may remove a directed edge in the graph and propagate the host spans using the remaining directed edges. If the two nodes are part of a group node, then the control node may determine if the connection would cause the group node to be separated into two or more other nodes. If not required, then no changes are required in the graph. However, if a separation is required, then the control node may separate the group node into two or more nodes and propagate the host spans using the directed edges.

In some implementations, the second graph may be updated based on status reports provided in association with the host systems of the computing environment. In particular, the host for the various logical entities may migrate as a function of time. Thus, while a logical entity may operate as part of a first host for a first period, the logical entity may operate as part of a second host for a second entity. To respond to the changes, the control system may update the graph based on the reports and update the host span for each of the nodes using the directional edges in the updated version of the second graph.

In some examples, by maintaining the second graph, the control system may conserve memory by consolidating nodes that would otherwise be included in the first graph. For example, the first graph would include three extra nodes that are not required by the second node. In particular, the second graph may consolidate entity nodes 114-115 and 117-118 into group node 130. Additionally, by limiting the quantity of nodes within the graph, processing resources may be conserved by the routing system when traversing the graph.

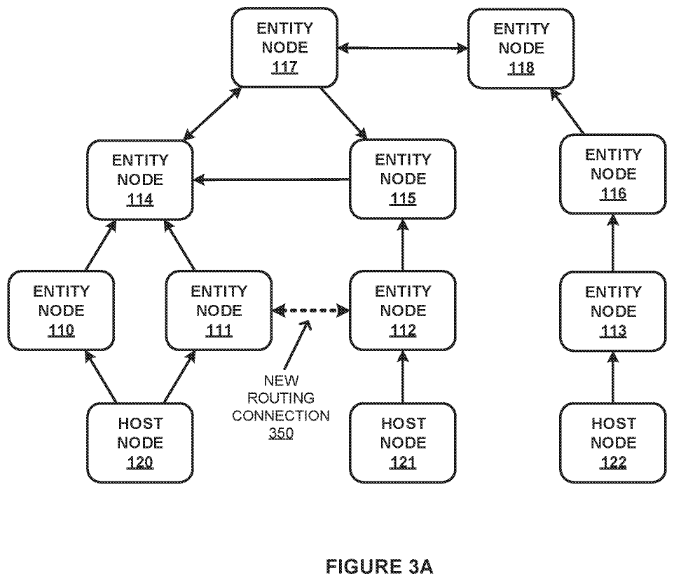

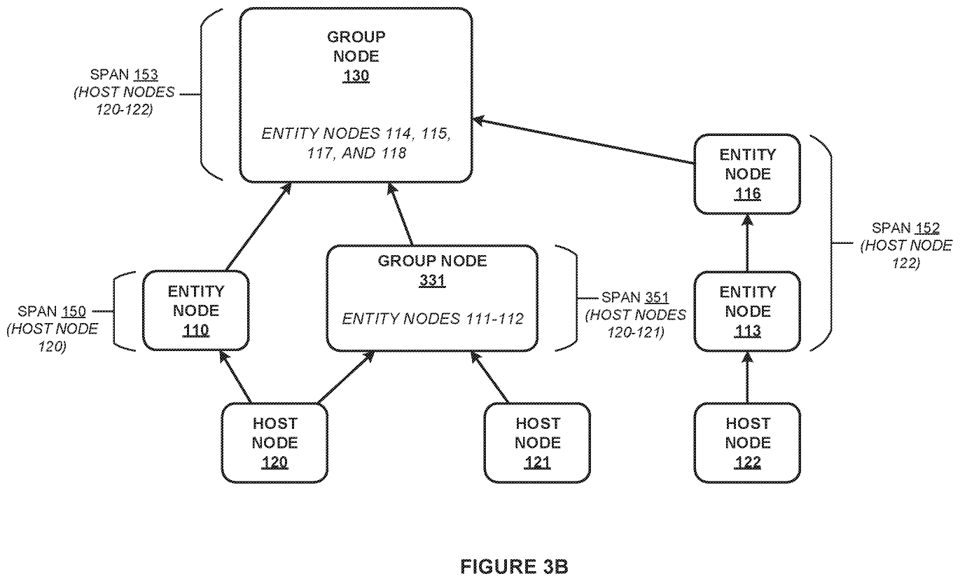

FIGS. 3A and 3B illustrate an example update to a software defined networking configuration according to an implementation. FIG. 3A includes nodes from graph 100 of FIG. 1A and further includes a new directed edge representative of a new routing connection 350. FIG. 3B includes nodes from graph 101 but replaces entity nodes 111-112 with group node 331.

Referring first to FIG. 3A, a control system may monitor for configuration modifications in software defined networks of a computing environment. These configuration modifications may be initiated by an administrator associated with the software defined networks and may include additions of logical entities, deletions of logical entities, additions of links between logical entities, removal of links between logical entities, or some other modification. When a modification is generated, the control system may reflect the update in a first graph associated with software defined network, wherein the first graph may include nodes that each represent a logical entity or host, and wherein the directional edges represent at least routing dependencies for the logical entities or a topology associated with the logical entities and hosts. Here, a modification corresponds to a bidirectional edge being created for new routing connection 350 between entity node 111 and entity node 112.

Turning to FIG. 3B, once a modification is identified, the control system may update a group graph based on the new edge. In some implementations, the control system may add a new edge or edges in the second graph to reflect the topology update to the software defined network. Once added, the control system may determine if any new strongly connected components are present in the second graph. Here, as a result of the bidirectional edge between entity node 111 and entity node 112, entity node 111 and entity node 112 may be combined into a new group node 331. Once the new group node is used to replace the entity nodes, the control system may determine if any additional strongly connected components exist in the graph. If no additional strongly connected components exist (such as the example in FIG. 3B), the update to the second graph is completed. Once completed the host spans may be propagated in the graph by traversing the directional edges of the graph. In the present implementation, because group node 331 is now is coupled to host nodes 120-121 via directional edges from host nodes 120-121, group node 331 now corresponds to span 351, which includes hosts associated with host nodes 120-121.

Although this is one example of updating a group graph, it should be understood that other updates may be made to the graph. These updates may include adding nodes to represent logical entities, migrating logical entities between hosts, or some other similar operation.

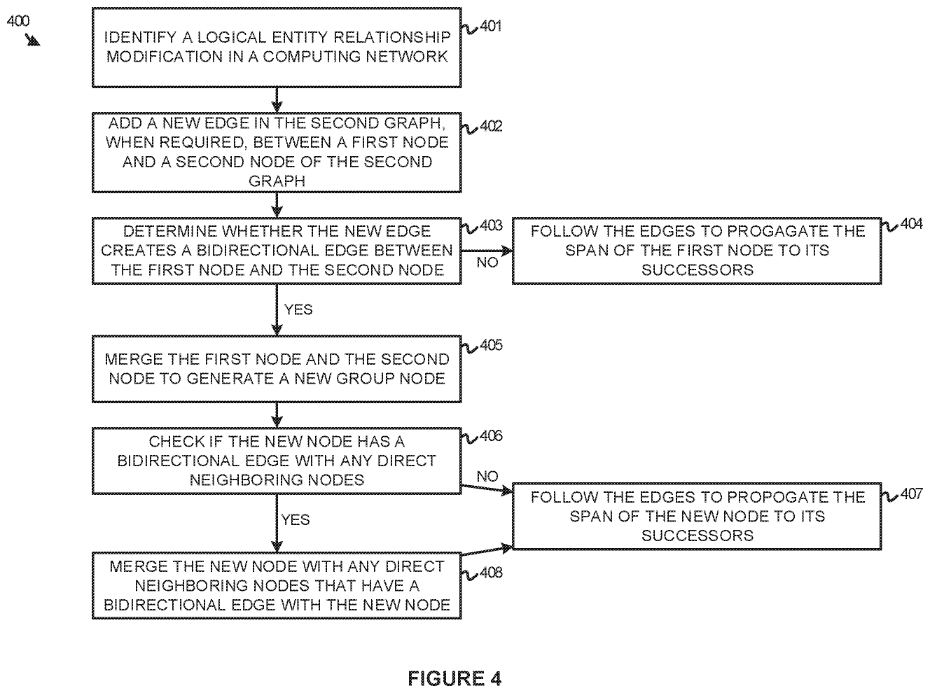

FIG. 4 illustrates an operation 400 of a control system to manage updates in graphs according to an implementation. Operation 400 is referenced parenthetically in the paragraphs that follow.

As depicted, operation 400 includes identifying (401) a logical entity relationship modification in a software defined network. The modification may include adding or removing logical entities in the network, adding or removing relationships between the entities in the network, or some other modification to the network. Once a modification is identified, operation 400 further adds (402) a new edge in a graph, when required, between a first node and a second node of the graph, wherein the graph is capable of supporting group nodes. For example, an administrator may generate a modification to a software defined network that couples a first logical switch to a second logical switch. As a result, a new directional edge may be added to the graph that couples the corresponding logical entities in the graph. In some implementations, the modification to the network may not require the addition of one or more directional edges. For instance, if an edge is to be added between two logical entities that are already associated in a group node, then the second graph is not required to be updated.

Once an edge is added, operation 400 determines (403) whether the new edge creates a bidirectional edge between the first node and the second node. If the new edge does not create a bidirectional edge between the first node and the second node, then the control system may follow (404) the edges of the graph to propagate the span of the first node to its successor nodes. In contrast, if the new edge does create a bidirectional edge between the first node and the second node, then the control system may merge (405) the first node and the second node to generate a new group node.

After the new group node is generated, the control system may check (406) if the new group node has any bidirectional edge with any direct neighboring nodes. If the new group node does not have any bidirectional edges with neighboring nodes, then the control system follows (407) the edges to propagate the span of the new node to its successors. However, if the new group node does have bidirectional edges with neighboring nodes, the controller may merge (408) the new node with any direct neighbor nodes that have a bidirectional edge with the new node and follow (407) the edges in the graph to propagate the span of the new node to its successors.

As an example, using FIG. 3B, when a new edge is generated between entity nodes 111-112, the nodes would share a bidirectional edge. As a result, entity node 111 may be merged with entity node 112 to form group node 331. Once merged, the host span from entity node 111 may be merged with entity node 112 and the span propagated as required in the graph. Although demonstrated as merging two nodes in the example of FIG. 3B, it should be understood that any number of nodes may be merged in response to the modification of the software defined network.

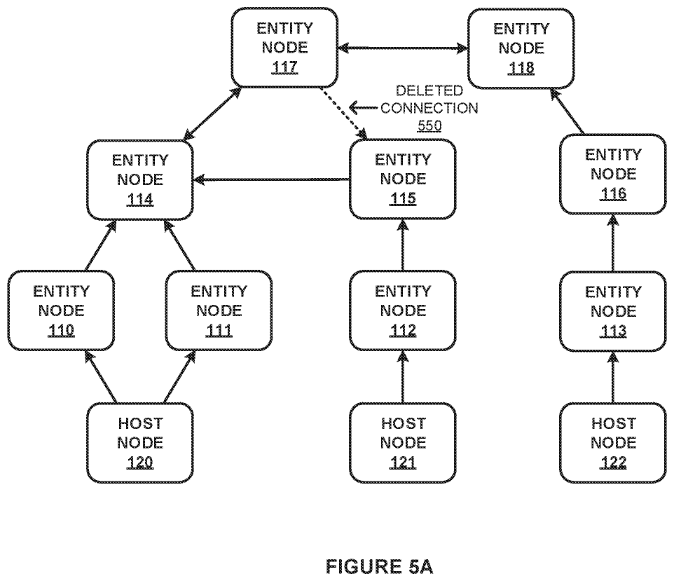

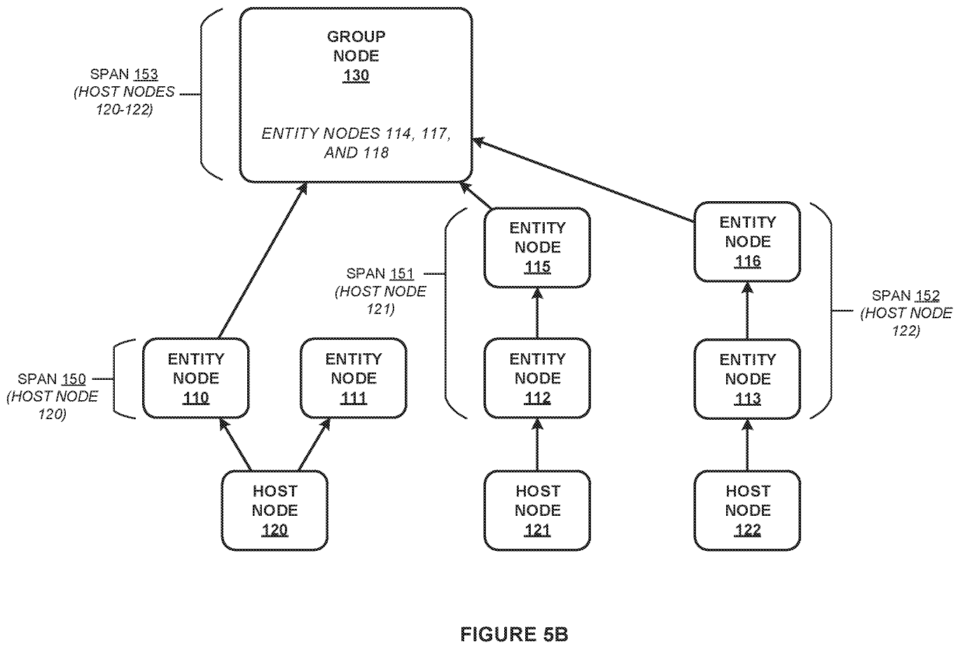

FIGS. 5A and 5B illustrate an example update to a software defined networking configuration according to an implementation. FIG. 5A includes elements of graph 100 of FIG. 1A and further includes deleted connection 550. FIG. 5B includes elements from graph 101 of FIG. 1B, wherein FIG. 1B demonstrates a graph with merged entity nodes based on the nodes being strongly connected.

Referring first to FIG. 5A, in response to a configuration modification of a software defined network, the controller may determine a change to the topology of the network. Here, the coupling between entity node 117 and entity node 115 is removed as part of the configuration modification. Although demonstrated as removing a connection, it should be understood that a modification may also remove entity nodes, which are representative of logical routers, logical switches, virtual or logical network interfaces associated with virtual nodes, or some other logical entity of a computing environment.

Turning to FIG. 5B, when the modification is requested for the software defined network, the control system may update the group node graph based on the modification. In some implementations, the control system may determine whether the modification is associated with logical entities that share a group node. If the modification is not associated with group node, then the control system may propagate the host span based on the directional edges in the graph. However, if the modification is associated with a group node, the control system may determine whether the entities of the group node still share a group node as strongly connected components. Here, because the edge is removed that is associated with the connection from entity node 117 to entity node 115, entity node 115 is no longer strongly connected with the other nodes of group node 130. As a result, entity node 115 is removed from group node 130 and an edge is created from entity node 115 to group node 130 in association with the topology connection of entity node 115 to entity node 117. In particular, because entity node 115 is connected to entity node 117 using a directed edge, entity node may include a directed edge to group node 130 in the group graph. Once connected, the control system may follow the directed edges of the graph in FIG. 5B to propagate the span of the nodes. In particular because entity node 115 is no longer associated with group node 130, entity node 115 may be associated with span 151 that corresponds to a host associated with host node 121.

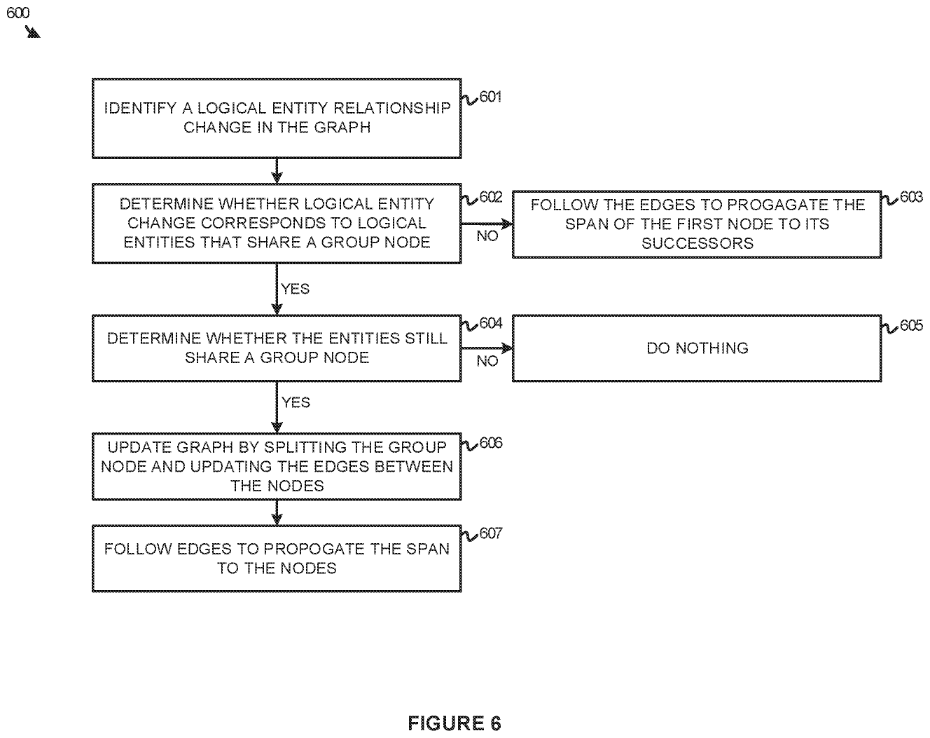

FIG. 6 illustrates an operation 600 of a control system to manage updates in graphs according to an implementation. The processes of operation 600 are referenced parenthetically in the paragraphs that follow.

As described herein, graphs may be generated based on an administrator defined logical entity topology and reports obtained in association with nodes of a computing environment. In at least one example, a graph is generated that can include group nodes that are representative of logical entities with strongly connected components. In addition to the group nodes, the graph may include nodes representative of logical entities that do not share strongly connected components and hosts in the computing environment. Additionally, the graph may include edges that are used to represent a dependency topology for the various nodes in the graph.

Once an initial graph is generated for the software defined network, changes may be made to the configuration of the software defined network. These changes may include the removal of logical entities, the removal of connections or associations between logical entities, the migration of logical entities, or some other change to the configuration. In response to the modification, the control system may be required to update the graph to reflect the modification. In the example of operation 600, operation 600 may identify (601) a logical entity relationship change in the graph capable of supporting group nodes, wherein the change may comprise any of the aforementioned configuration changes.

In response to identifying the change, operation 600 may determine (602) whether the change corresponds to logical entities that share a group node. If the logical entities affected do not share a group node, then operation 600 may follow (603) the directed edges remaining in the graph to propagate the span of the first node to its successors. In contrast, if the logical entities affected by the change do share a group node, operation 600 will determine (604) whether the entities still share group node after the modification. In determining whether the logical entities continue to share a group node, the control system may determine whether the logical entities remain strongly connected components. If the nodes remain strongly connected, then the operation may do nothing (605) and stop any further actions with respect to the graph. However, if the entities no longer share a group node, the control system may update (606) the graph by splitting the group node and updating the edges between the nodes.

For example, if a configuration is changed between a first logical entity and a second logical entity that share a common group node. The modification may cause at least one of the logical entities to no longer be strongly connected with one or more other logical entities represented in the group. As a result, the group node may be split into two or more nodes, wherein the two or more nodes may comprise group nodes or may comprise individual entity nodes that represent a logical entity. Once a group node is split, operation 600 may follow (607) the directed edges in the graph to propagate the span to the nodes.

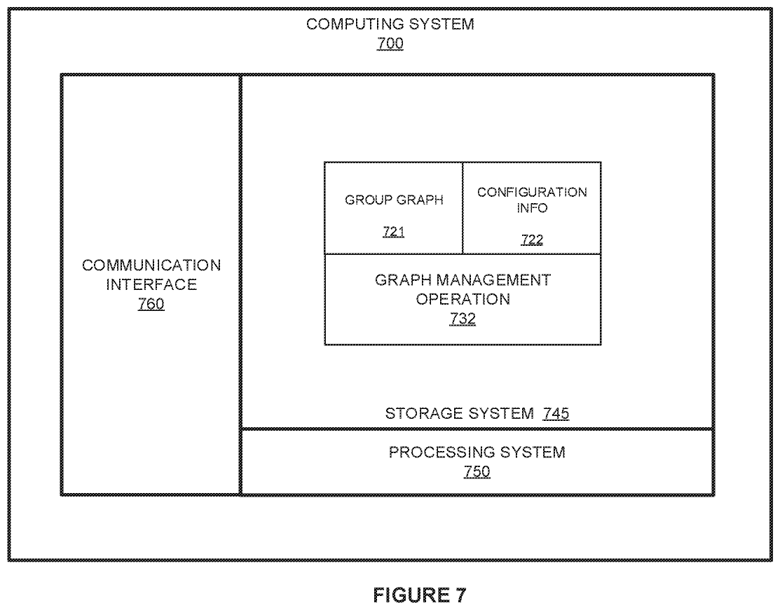

FIG. 7 illustrates a computing system 700 according to an implementation. Computing system 700 is representative of any computing system or systems with which the various operational architectures, processes, scenarios, and sequences disclosed herein for a host can be implemented. Computing system 700 is an example of computing entity 101 of FIG. 1, although other examples may exist. Computing system 700 includes storage system 745, processing system 750, and communication interface 760. Processing system 750 is operatively linked to communication interface 760 and storage system 745. Communication interface 760 may be communicatively linked to storage system 745 in some implementations. Computing system 700 may further include other components such as a battery and enclosure that are not shown for clarity.

Communication interface 760 comprises components that communicate over communication links, such as network cards, ports, radio frequency (RF), processing circuitry and software, or some other communication devices. Communication interface 760 may be configured to communicate over metallic, wireless, or optical links. Communication interface 760 may be configured to use Time Division Multiplex (TDM), Internet Protocol (IP), Ethernet, optical networking, wireless protocols, communication signaling, or some other communication format—including combinations thereof. Communication interface 760 is an example of a physical network interface that can be configured to communicate with other computing systems to provide required operations for the processes executing on computing system 700. In some implementations, communication interface 760 may communicate with hosts of a computing environment to identify logical entities available on the various hosts.

Processing system 750 comprises microprocessor and other circuitry that retrieves and executes operating software from storage system 745. Storage system 745 may include volatile and nonvolatile, removable and non-removable media implemented in any method or technology for storage of information, such as computer readable instructions, data structures, program modules, or other data. Storage system 745 may be implemented as a single storage device but may also be implemented across multiple storage devices or sub-systems. Storage system 745 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. It should be understood that in no case is the storage media a propagated signal.

Processing system 750 is typically mounted on a circuit board that may also hold the storage system. The operating software of storage system 745 comprises computer programs, firmware, or some other form of machine-readable program instructions. The operating software of storage system 745 comprises graph management operation 732. The operating software on storage system 745 may further include utilities, drivers, network interfaces, applications, or some other type of software. When read and executed by processing system 750 the operating software on storage system 745 directs computing system 700 to operate as described herein. Storage system 745 further stores group graph 721 and configuration information 722.

In at least one implementation, graph management operation 732 directs processing system 750 to identify a first graph for a computing environment, wherein the first graph comprises nodes that represent one or more hosts and one or more logical entities of a software defined network, and wherein the first graph further comprises directional edges that indicate a topology of the nodes. In some examples, the first graph may be generated based on a network configuration provided by one or more administrators, wherein the configuration may indicate relationships between the various logical entities, and may be further generated based on reports indicating the hosts on which the various logical entities reside. This information is represented in FIG. 7 as configuration information 722. Once the first graph is identified, graph management operation 732 may direct processing system 750 to identify one or more groups of strongly connected components in the first graph. From the strongly connected components, graph management operation 732 may generate a second graph (group graph 721) based on the identified one or more groups, wherein the second graph comprises nodes that represent the one or more groups and any nodes of the first graph not included in the one or more groups, and wherein the second graph further comprises directional edges that indicate a topology of the nodes in the second graph. This topology may indicate what virtual network interfaces are on what host, what logical switches are coupled to which of the virtual network interfaces, or some other topology associated with the logical elements and the host computing systems.

Once the second graph is generated, the graph management operation 732 may identify a span of hosts for each of the nodes in the second graph based on the directional edges of the second graph. In at least one example, the second graph may be traversed starting at the nodes associated with the host computing system. For each logical entity that is encountered from a host, the host may be added to the span of that corresponding logical entity. After allocating the span to each of the logical entities, update requests may be generated to update or change a configuration associated with one of the logical entities. A configuration modification may include a firewall update, a routing update, or some other configuration modification. To determine the hosts associated with the modification, control system 700 may identify the node in the second graph that corresponds to the logical entity and the span associated with the node. The hosts identified with the span may then be provided with the required configuration update information to support the request for the network.

In some implementations, the topology for the software defined network may be dynamic based on the configuration provided by the administrators or based on migrations on the host computing systems. For example, while a virtual network interface may be located on a first host for a first period, the virtual network interface may be migrated to a second host for a second time period. In response to the migration, computing system 700 may identify the change and determine any required modifications to the structure of the second graph. These modifications may include adding, removing, or moving nodes in the graph, adding or removing directional edges in the graph, or providing some other operation with respect to the graph.

In some examples, when a modification is generated for the graph, computing system 700 may determine whether any new strongly connected components exist in the second graph. When the new components exist, the nodes that are strongly connected may be combined into a group node and the edges of the graph updated to reflect the newly formed group nodes. Additionally, when a change is made in the second graph, the spans may be propagated for each of the hosts to the various logical entity nodes and group nodes in the graph.

In other examples, rather than adding group nodes to the graph, computing system 700 may be used to update the second graph by splitting previously generated group nodes. For instance, a modification to a network may require the removal of a directed edge from a first logical entity to a second logical entity. Based on the removal of the directed edge, the second logical entity may no longer comprise a strongly connected component with the first logical entity. When this occurs, the group node may be split in the second graph and the directed edges may be updated to reflect the changes. Additionally, when a change is made in the second graph, the spans may be propagated for each of the hosts to the various logical entity nodes and group nodes in the graph.

In some implementations, by generating a graph with group nodes, computing system 700 may conserve memory by consolidating nodes that would otherwise be included in the original non-grouped graph. Additionally, by limiting the quantity of nodes in the graph, processing resources of computing system 700 may be conserved when traversing the graph.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

What is claimed is:

1. A method comprising:
identifying a first graph, wherein the first graph comprises nodes that represent one or more hosts and one or more logical entities of a software defined network, and wherein the first graph further comprises directional edges that indicate a topology of the nodes in the first graph;
identifying one or more groups of strongly connected components in the first graph;
generating a second graph based on the identified one or more groups, wherein the second graph comprises nodes that represent the one or more groups and any nodes of the first graph not included in the one or more groups, and wherein the second graph further comprises directional edges that indicate a topology of the nodes in the second graph; and
identifying a host span for each of the nodes in the second graph based on the directional edges of the second graph.

2. The method of claim 1, wherein the logical entities comprise one or more logical switches or logical routers.

3. The method of claim 1 further comprising generating the first graph based on a user generated network configuration for the software defined network and host status reports, wherein the host status reports indicate one or more logical entities executing on each host of the one or more hosts.

4. The method of claim 1 further comprising:
obtaining a request to modify a configuration of a logical entity;
identifying a host span associated with the logical entity based on the second graph; and
initiating a configuration modification on one or more hosts associated with the host span.

5. The method of claim 1 further comprising:
identifying a request to update a relationship between two logical entities in the second graph;
generating a directional edge in the second graph based on the request;
determining that two or more of the nodes in the second graph comprise strongly connected components using the directional edge;
combining the two or more nodes as a new group node in the second graph; and
updating the host spans based on the directional edges.

6. The method of claim 1 further comprising:
identifying a request to update a relationship between two logical entities in the second graph;
determining that the two logical entities share a group node in the second graph;
identifying that the two logical entities will not share the group node after the relationship update;
in response to identifying that the two logical entities will not share the group node after the relationship update, updating the second graph by splitting the group node into two or more nodes; and
updating the host spans based on the directional edges.

7. The method of claim 1, wherein at least a portion of the directional edges in the second graph indicate routing dependencies.

8. The method of claim 1 further comprising:
obtaining host status reports, wherein the host status reports indicate one or more logical entities executing on each host of the one or more hosts;
updating the second graph based on the host status reports; and
updating the host spans in the second graph based on the directional edges.

9. A computing system comprising:
a storage system;
a processing system operatively coupled to the storage system; and
program instructions stored on the storage system that, when executed by the processing system, direct the processing system to:
identify a first graph, wherein the first graph comprises nodes that represent one or more hosts and one or more logical entities of a software defined network, and wherein the first graph further comprises directional edges that indicate a topology of the nodes in the first graph;
identify one or more groups of strongly connected components in the first graph;
generate a second graph based on the identified one or more groups, wherein the second graph comprises nodes that represent the one or more groups and any nodes of the first graph not included in the one or more groups, and wherein the second graph further comprises directional edges that indicate a topology of the nodes in the second graph; and
identify a host span for each of the nodes in the second graph based on the directional edges of the second graph.

10. The computing system of claim 9, wherein the logical entities comprise one or more logical switches or logical routers.

11. The computing system of claim 9, wherein the program instructions further direct the processing system to generate the first graph based on a user generated network configuration for the software defined network and a host status reports, wherein the host status reports indicate one or more logical entities executing on each host of the one or more hosts.

12. The computing system of claim 9, wherein the program instructions further direct the processing system to:
obtain a request to modify a configuration of a logical entity;
identify a host span associated with the logical entity based on the second graph; and
initiate a configuration modification on one or more hosts associated with the host span.

13. The computing system of claim 9, wherein the program instructions further direct the processing system to:
identify a request update a relationship between two logical entities in the second graph;
generate a directional edge in the second graph based on the request;
determine that two or more of the nodes in the second graph comprise strongly connected components using the directional edge;
combine the two or more nodes as a new group node in the second graph; and
update the host spans based on the directional edges.

14. The computing system of claim 9, wherein the program instructions further direct the processing system to:
identify a request to update a relationship between two logical entities in the second graph;
determine that the two logical entities share a group node in the second graph;
identify that the two logical entities will not share the group node after the relationship update;
in response to identifying that the two logical entities will not share the group node after the relationship update, update the second graph by splitting the group node into two or more nodes; and
update the host spans based on the directional edges.

15. The computing system of claim 9, wherein the program instructions further direct the processing system to:
identify a request to update a relationship between two logical entities in the second graph;
determine that the two logical entities do not share a group node in the second graph;
in response to determining that the two logical entities will not share the group node after the relationship update, update the second graph by removing a directional edge between two nodes that correspond to the two logical entities; and
updating the host spans based on remaining directional edges in the second graph following the removal of the directional edge.

16. The computing system of claim 9, wherein at least a portion of the directional edges in the second graph indicate routing dependencies.

17. The computing system of claim 9, wherein the program instructions further direct the processing system to:
obtain host status reports, wherein the host status reports indicate one or more logical entities executing on each host of the one or more hosts;
update the second graph based on the host status reports; and
update the host spans based on the directional edges.

18. An apparatus comprising:
a storage system; and
program instructions stored on the storage system that, when executed by a processing system, direct the processing system to:
generate a first graph based on a user generated network configuration for the software defined network and a host status reports, wherein the host status reports indicate one or more logical entities executing on each host of the one or more hosts, wherein the first graph comprises nodes that represent one or more hosts and one or more logical entities of a software defined network, and wherein the first graph further comprises directional edges that indicate a topology of the nodes in the first graph;
identify one or more groups of strongly connected components in the first graph;
generate a second graph based on the identified one or more groups, wherein the second graph comprises nodes that represent the one or more groups and any nodes of the first graph not included in the one or more groups, and wherein the second graph further comprises directional edges that indicate a topology of the nodes in the second graph; and
identify a host span for each of the nodes in the second graph based on the directional edges of the second graph.

19. The apparatus of claim 18, wherein the logical entities comprise one or more logical switches, logical routers, or virtual network interfaces.

20. The apparatus of claim 18, wherein the program instructions further direct the processing system to:
obtain a request to modify a configuration of a logical entity;
identify a host span associated with the logical entity based on the second graph; and
initiate a configuration modification on one or more hosts associated with the host span.
